(19) United States
(12) Patent Application Publication
(10) Pub. No.: US 2018/0277808 A1
(43) Pub. Date: Sep. 27, 2018

(54) Battery Pack Module

(71) Applicant: Martin Kruszelnicki, Santa Monica, CA (US)

(72) Inventor: Martin Kruszelnicki, Santa Monica, CA (US)

(21) Appl. No.: 15/937,728

(22) Filed: Mar. 27, 2018

Related U.S. Application Data
(60) Provisional application No. 62/601,643, filed on Mar. 27, 2017.
(60) Provisional application No. 62/603,941, filed on Jun. 16, 2017.

(51) Int. Cl. H01M 2/10; H01M 2/20; H01M 10/613; H01M 10/625; H01M 10/6557

(52) U.S. Cl. CPC H01M 2/1077; H01M 2/206; H01M 2220/20; H01M 10/625; H01M 10/6557; H01M 10/613

(57) ABSTRACT

A battery pack module assembly includes a housing having a main body, a first cover, and a second cover. The first cover matingly engages a first side of the main body, and the second cover matingly engages a second side of the main body. The first and second sides are on opposite sides of the main body. The main body includes an interior having a plurality of hollow cylinders, with each hollow cylinder configured for insertion of at least one battery cell within an interior of the hollow cylinder. At least one port provides an inlet for coolant moving into the interior of the main body, and an outlet for coolant moving out from the interior of the main body. The interior of the housing is configured for coolant to flow therewithin and around at least a portion of an exterior surface of each hollow cylinder. Coolant does not contact battery cells disposed within hollow cylinders. The assembly includes bus bars configured to provide electrical communication between at least two battery cells.

### BACKGROUND

The present invention relates generally to battery packs. More particularly, the present invention relates to a battery pack module for an electric vehicle.

Traditional internal combustion engine motor vehicles (e.g., automobiles, trucks, and the like) have dominated transportation for the better part of a century. These traditional internal combustion motor vehicles, however, are powered by fossil fuels. Fossil fuels are known contributors to air pollution and climate change. In recent decades, alternatives to traditional internal combustion engine motor vehicles have arisen (e.g., electric vehicles (“EV”), and gasoline-electric hybrid (“Hybrid”) vehicles) as a way to mitigate climate change, air pollution, and the like. These alternative vehicles use rechargeable batteries to provide power for operation of the alternative vehicle (e.g., moving the vehicle) and powering various systems within the alternative vehicle. Individual batteries may be placed together within a battery pack.

Different types of battery packs associated with electric vehicles have been proposed. However, such battery packs have their limitations and can always be improved.

Accordingly, there is a need for an improved battery pack module for an electric vehicle. There is also a need for a battery pack module that provides uniform thermal management. There is an additional need for a battery pack module that is easier to manufacture, assemble, adjust, and maintain. The present invention satisfies these needs and provides other related advantages.

### SUMMARY

The battery pack module assembly illustrated herein provides an improved battery pack module. The battery pack module assembly illustrated herein provides an improved battery pack module for an electric vehicle. The battery pack module assembly illustrated herein provides uniform thermal management. The battery pack module assembly illustrated herein is easier to manufacture, assemble, adjust, and maintain.

In an illustrative embodiment, a battery pack module assembly includes a housing having a main body, a first cover, and a second cover. The first cover matingly engages a first side of the main body, and the second cover matingly engages a second side of the main body. The first and second sides of the main body are on opposite sides of the main body. The main body includes an interior having a plurality of hollow cylinders, with each hollow cylinder configured for insertion of at least one battery cell within an interior of the hollow cylinder. An inlet allows coolant to move into the interior of the main body, and an outlet allows coolant to move out from the interior of the main body. The interior of the housing is configured for coolant to flow therewithin and around at least a portion of an exterior surface of each hollow cylinder. Coolant does not contact battery cells disposed within hollow cylinders. The assembly includes bus bars, with each bus bar configured to provide electrical communication between at least two battery cells.

In another illustrative embodiment, the main body includes a divider wall defining the interior of the main body into upper and lower chambers. The upper and lower chambers are configured such that coolant is flowable from one chamber to the other chamber.

In a further illustrative embodiment, the exterior surface of each hollow cylinder includes a plurality of ribs for providing increased heat exchange surface with coolant, wherein coolant flowing around each hollow cylinder contacts at least a portion of the ribs.

In yet another illustrative embodiment, the main body is of single-piece construction.

In still another illustrative embodiment, the main body is constructed using 3D printing.

In another illustrative embodiment, the main body comprises dielectric thermal conductive.

In an illustrative embodiment, a first end of each hollow cylinder is open on the first side of the main body.

In yet another illustrative embodiment, a second end of each hollow cylinder is open on the second side of the main body.

In another illustrative embodiment, at least one of the bus bars is disposed between the first cover and the main body, and configured to electrically engage battery cells disposed within the hollow cylinders on the first side of the main body.

In still another illustrative embodiment, at least one of the bus bars is disposed between the second cover and the main body, and configured to electrically engage battery cells disposed within the hollow cylinders on the second side of the main body.

In a further illustrative embodiment, the first cover includes a plurality of male fasteners, and the main body includes a plurality of female fasteners for matingly engaging the male fasteners of the first cover, whereby the first cover and the main body matingly engage when the male and female fasteners matingly engage.

In another illustrative embodiment, the second cover includes a plurality of male fasteners, and the main body includes a plurality of female fasteners for matingly engaging the male fasteners of the second cover, whereby the first cover and the main body matingly engage when the male and female fasteners matingly engage.

In yet another illustrative embodiment, each bus bar includes at least one recessed point configured to engage the battery cell in each hollow cylinder. Bus bars on opposite sides of the main body each provide compression against a side of the battery cell facing that particular bus bar such that there is electrical contact between the bus bars and the battery cell.

In another illustrative embodiment, the hollow cylinders are sized to accommodate at least two stacked battery cells. Each bus bar includes at least one recessed point configured to engage the at least one of the stacked battery cells in each hollow cylinder. Bus bars on opposite sides of the main body each provide compression against a side of the stacked battery cells facing that particular bus bar such that there is electrical contact between the bus bars and the stacked battery cells, and to provide compression between the at least two stacked battery cells.

In a further illustrative embodiment, the main body further includes a first plurality of supports interconnecting the hollow cylinders and the main body.

In an additional illustrative embodiment, the main body further includes a second plurality of supports interconnecting the hollow cylinders.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts:

FIG. 1 illustrates a perspective view of a main body of a battery pack module assembly in accordance with an embodiment of the present invention;

FIG. 2 illustrates an exploded perspective view of a battery pack module assembly in accordance with an embodiment of the present invention;

FIG. 3 illustrates a side view of the main body of FIG. 1;

FIG. 3A illustrates an enlarged view of a portion of the main body taken along line 3A of FIG. 3;

FIG. 4 illustrates a perspective cutaway view of a portion of the main body of FIG. 1;

FIG. 5 illustrates a cutaway, perspective view of a side of the main body of FIG. 1;

FIG. 6 illustrates a cross-sectional view of the portion of the main body, taken along line 6-6 of FIG. 5;

FIG. 7 illustrates a perspective view of the main body of FIG. 6;

FIG. 8 illustrates a view of the side of the main body of FIG. 5;

FIG. 9 illustrates a cross-sectional view of an expandable clip on one of the covers aligned with, but not engaging, a recess located on the rear side of the main body; and

FIG. 10 illustrates a cross-sectional view of the expandable clip of the cover engaging the recess of the rear side of the main body.

### DETAILED DESCRIPTION

The following detailed description describes present embodiments with reference to the drawings. In the drawings, reference numbers label elements of present embodiments. These reference numbers are reproduced below in connection with the discussion of the corresponding drawing features.

It is to be understood that the figures and descriptions of the present invention have been simplified to illustrate elements that are relevant for a clear understanding of the present invention, while eliminating, for the purpose of clarity, many other elements found in battery pack modules. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

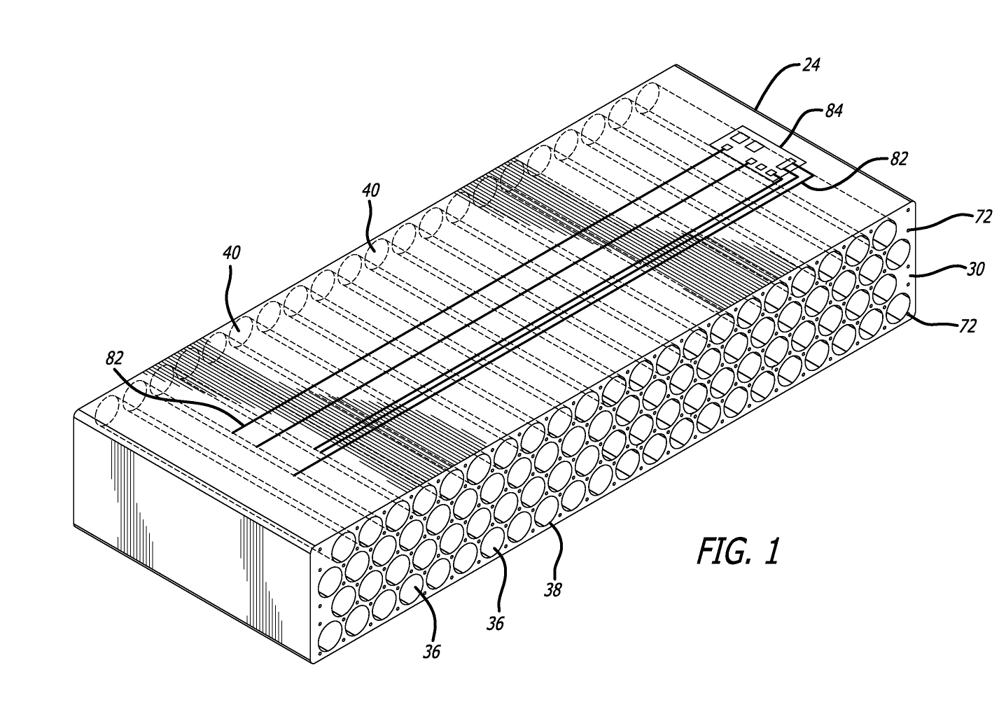

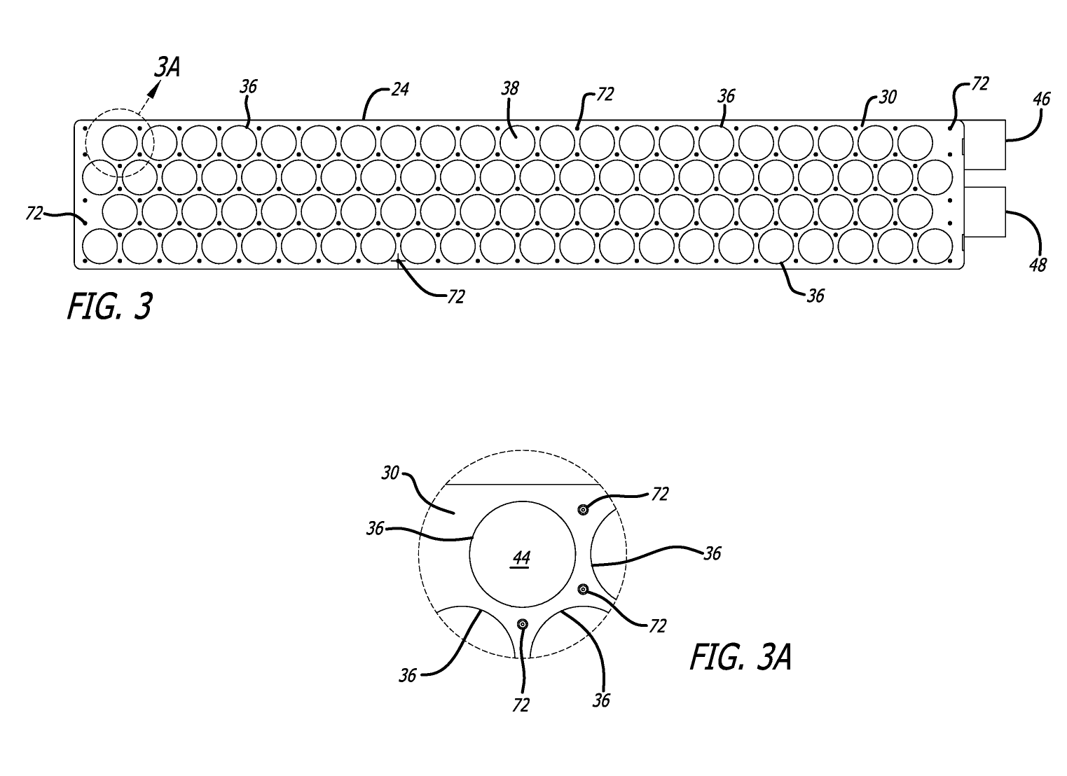

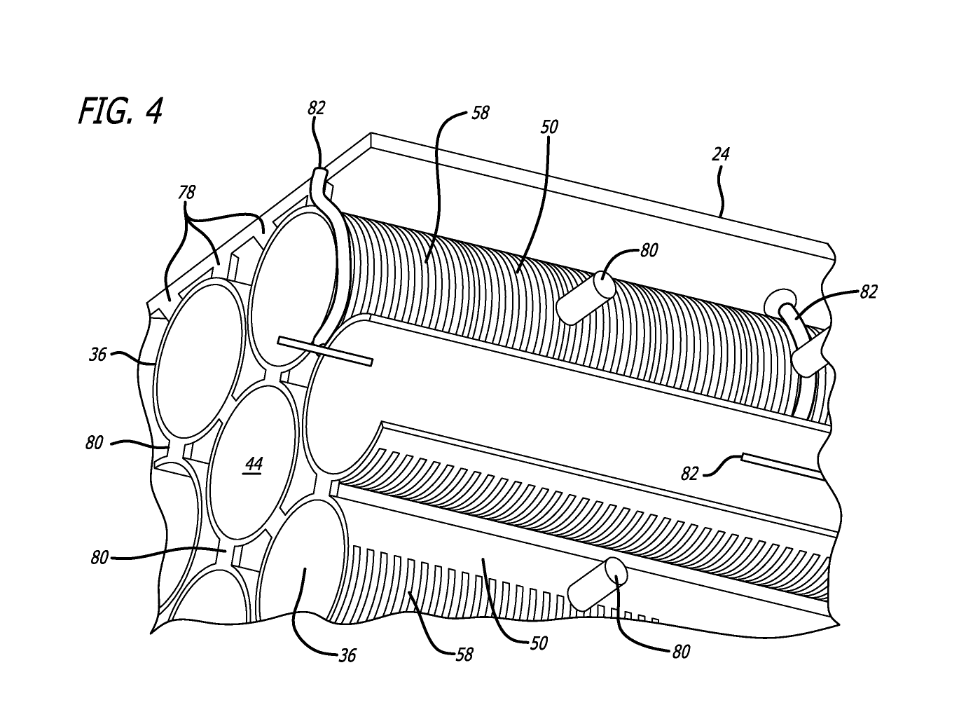

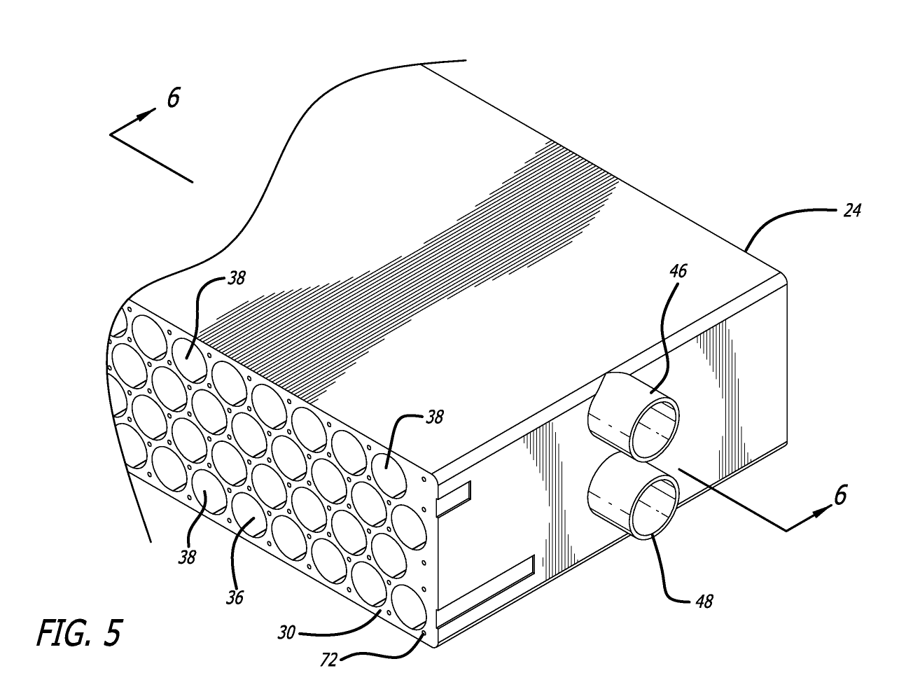

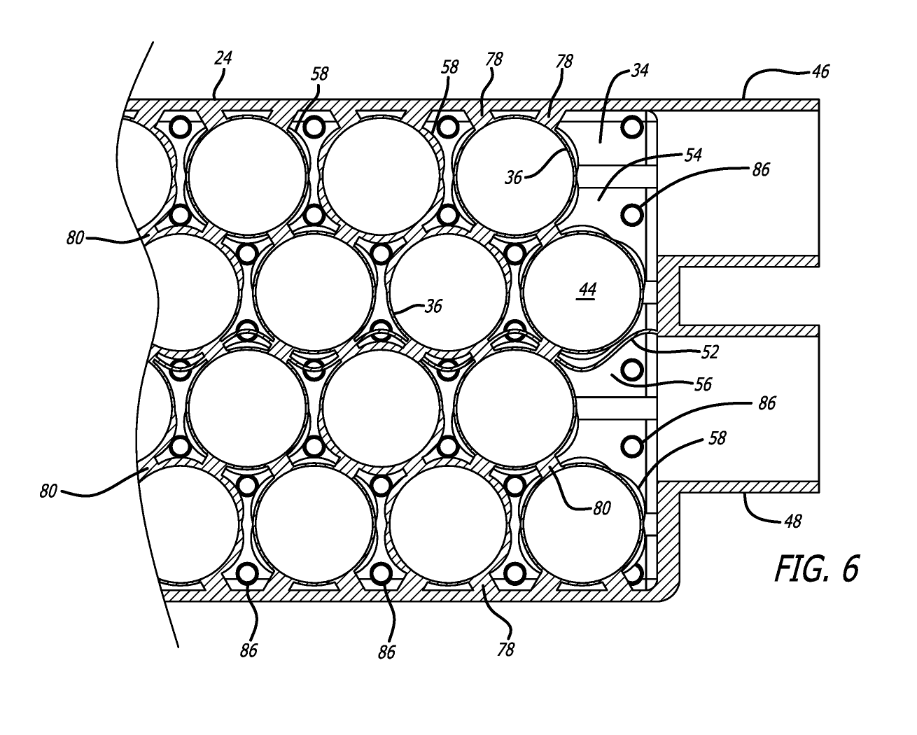

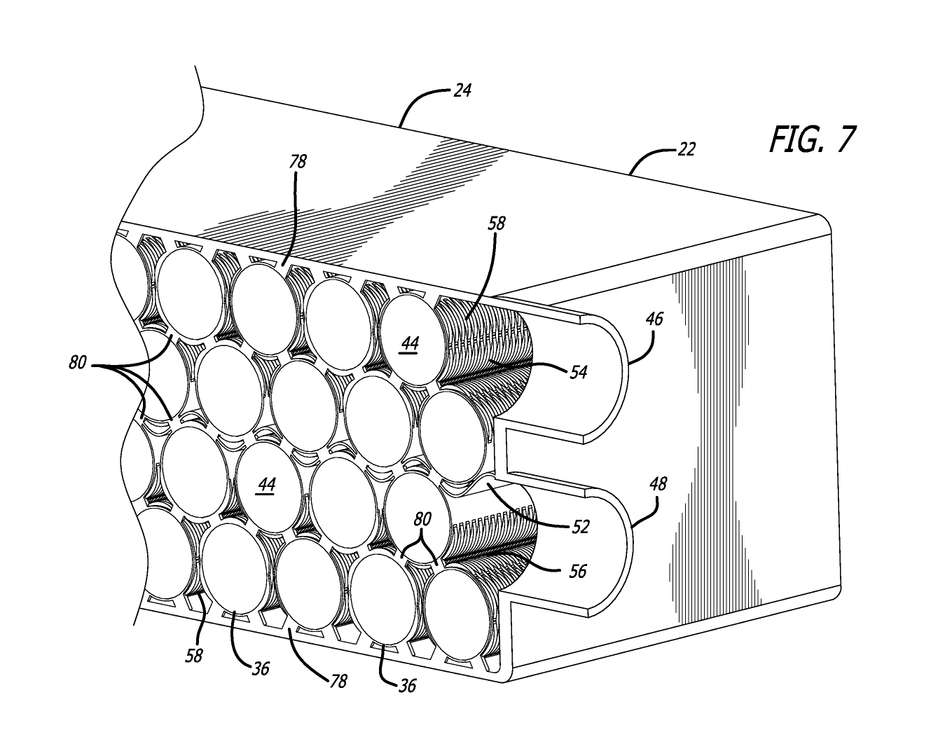

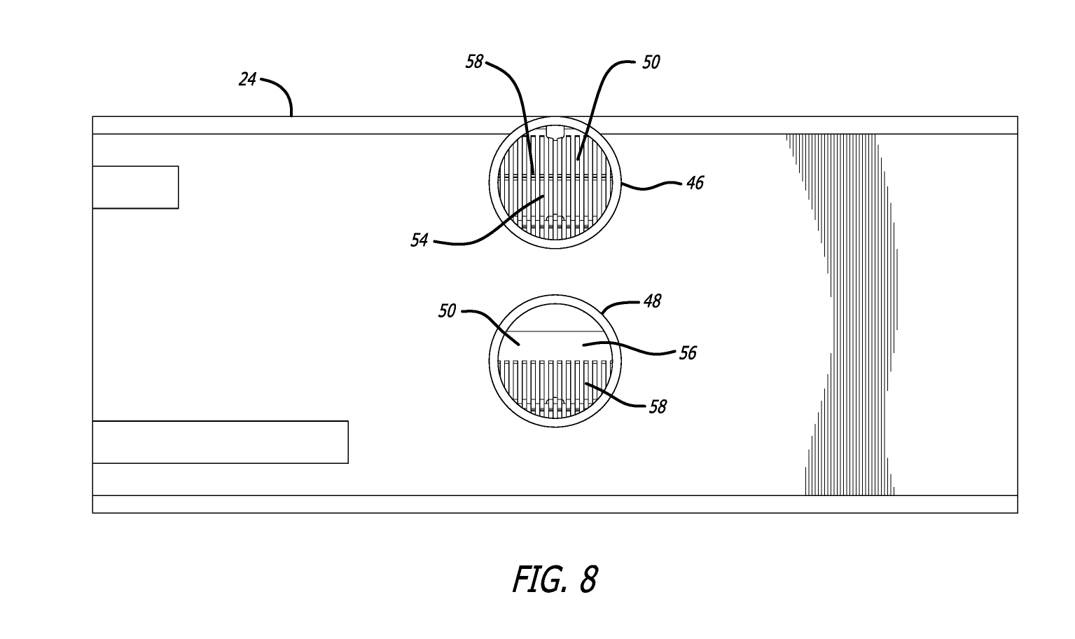

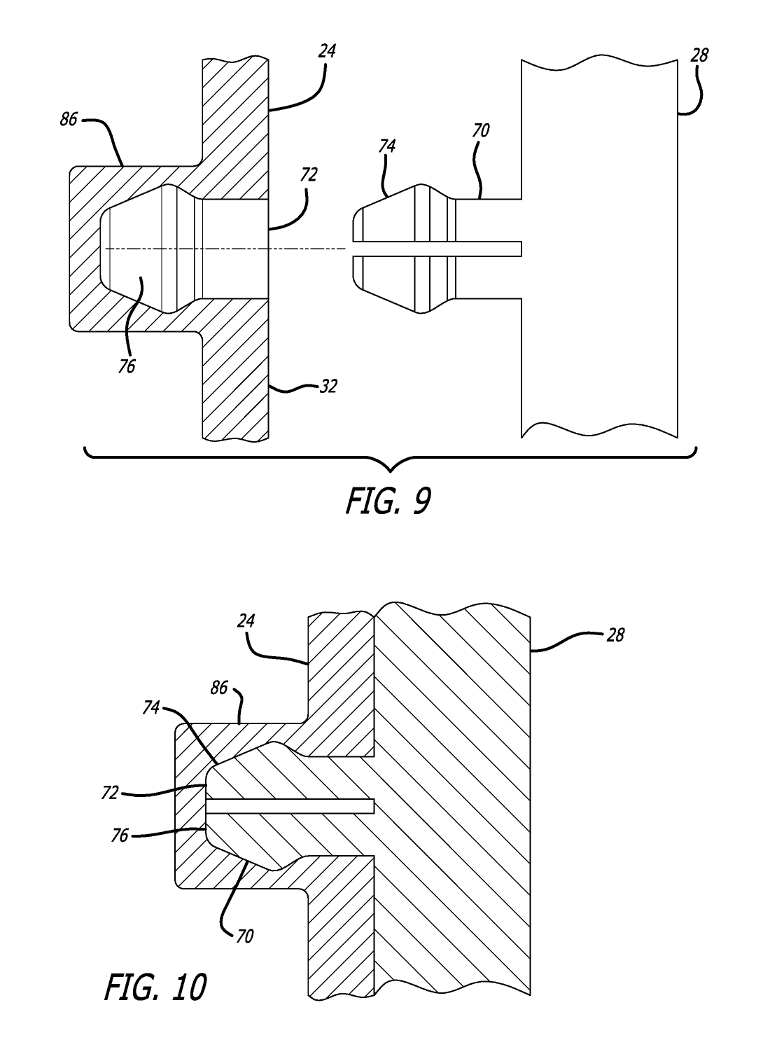

As shown in FIGS. 1-10 for purposes of illustration, an embodiment of the present invention resides in a battery pack module assembly 20 includes a housing 22 having a main body 24, a first or front cover 26, and a second or rear cover 28.

The front cover 26 matingly engages a first or front side 30 of the main body 24, and the second or rear cover 28 matingly engages a second or rear side 32 of the main body 24. The front and rear sides 30, 32 of the main body 24 are on opposite sides of the main body 24. The main body 24 includes an interior 34 having a plurality of bores or hollow cylinders 36. A first end of each hollow cylinder 36 has an opening 38 on the front side 30 (i.e., a front opening 38) of the main body 24, and a second end of each hollow cylinder 36 has an opening 40 on the rear side 32 (i.e., a rear opening 40) of the main body 24.

Each hollow cylinder 36 is configured for insertion of at least one generally cylindrical battery cell (not shown) within an interior 44 of the hollow cylinder 36. Each cylindrical bore 36 in the assembly 20 is designed to accommodate at least one (1) cylindrical battery cell. However, depending on the size of the hollow cylinders 36 and/or the battery cells, the hollow cylinder can accommodate more than one (1) battery cell. If, for example, there is more than one (1) battery cell in a single cylindrical bore 36, the battery cells are positioned in tandem (also referred to as being “stacked”) within the cylindrical bore 36. Depending on the design of the assembly 20, any number of battery cells from one (1) battery cell (i.e., not stacked) to several battery cells can be stacked in one hollow cylinder 36. Various materials may be disposed in between stacked cells to improve inter-cell electrical connection including, but not limited to, a copper allow powder (not shown), an electrically conductive compound (e.g., an electrically conductive glue), or the like.

The main body 24 has a generally rectangular shape, and the lengths of all the cylindrical bores 36 are equal. If, for example, the cylindrical bore 36 can accommodate three (3) stacked battery cells (each battery cell having the same size/length), then no cylindrical bore 36 in the assembly 20 will contain less than three (3) battery cells (unless a hollow cylinder 36 is left empty). Alternatively, the main body 24 can be irregularly-shaped such that a portion of the main body 24 is sized to include at least one hollow cylinder 36 capable of holding only one (1) battery cell of a particular size, while at least one (1) other portion of the main body 24 is sized to include at least one hollow cylinder 36 capable of holding two (2) or more battery cells. The battery cell can be a rechargeable battery (e.g., a lithium-ion battery, lead-acid, nickel metal hydride, etc.). The battery cell can be any battery in cylindrical form factor (e.g., 18650, 21700, etc.). The body or casing of the battery cell is made from nickel-plated steel. The battery cell casing has a negative terminal along the sides and bottom of the casing and has a positive terminal only on a top portion of the battery cell. The casing of the battery cell is a negative terminal throughout the length of the battery cell and conductive circuitry 82 of a battery monitoring system 84 makes direct electrical and physical contact with the exterior surface of the battery cell. Each hollow cylinder 36 has an inner diameter sized and shaped to friction-fit a generally cylindrical battery cell inserted within the interior 44 of the hollow cylinder 36. Alternatively, if a particular battery cell has an outer diameter less than the interior diameter of the hollow cylinder 36, an electrically conductive and/or thermally conductive sleeve may be positioned around that particular battery cell such that electrical and/or thermal contact is made between the battery cell and the hollow cylinder 36. In another alternative, the battery cell can be in other forms (e.g., rectangular), with the shape of bore 36 being a similar shape for receiving one or more of the similarly-shaped battery cells therewithin.

The main body 24 includes at least one port 46 that provides an inlet for liquid coolant (not shown) moving into the interior 34 of the main body 24 (i.e., an inlet port 46), and at least one port 48 that provides an outlet for coolant moving out from the interior 34 of the main body 24 (i.e., an outlet port 48). The ports 46, 48 are located on the same side of the main body 24. Alternatively, the inlet port 46 and the outlet port 48 may be disposed on opposite sides of the main body 24 from each other, or on such various sides of the main body 24 as is required to accommodate a particular layout required for positioning the ports 46, 48. The interior 34 of the housing 22 is configured for coolant (not shown) to flow therewithin (coolant channels through which coolant flows being defined by the space not taken up by the hollow cylinders 36 and supports 78, 80) and around at least a portion of an exterior surface 50 of each hollow cylinder 36. Various coolants may be used including, without limitation, a glycol-water mixture or any other liquid used in heat transfer applications. Coolant flowing within the interior 34 of the main body 24 does not come into contact with any of the battery cells disposed within the hollow cylinders 36. The coolant originates from a coolant reservoir (not shown) located external to the battery pack module assembly 20, and at least one pump (not shown) located external to the battery pack module assembly 20 is used to pump the liquid coolant into and out from the interior of the main body 34 through the ports 46, 48. In the alternative, the main body 24 may include a single port used for both intake and outtake of coolant (the port may be configured such that coolant moving into the interior 34 of the main body 24 is kept separate from the coolant moving out from the interior 34 of the main body 24. Coolant flows through the interior 34 of the main body 24 and circulates uniformly around every hollow cylinder 36, and from top-to-bottom, and side-to-side of the interior 34.

In another illustrative embodiment, the main body 24 includes a divider wall 52 that divides the interior 34 of the main body 24 into upper and lower chambers 54, 56. The upper and lower chambers 54, 56 are configured such that coolant is flowable from one chamber to the other chamber. For example, when the inlet port 46 and the outlet port 48 are located on the same side of the main body 24, the divider wall 52 does not extend in the interior 34 all the way to the opposite side wall of main body 24 and defines an aperture (not shown) through which coolant passes. If the inlet portion 46 is located such that coolant enters the main body 24 into the upper chamber 54, the coolant will flow within the interior 34 to the opposite end of the main body 24, move down into the lower chamber 56 and flow back towards the outlet port 48. Alternatively, divider wall 52 may extend within the interior 34 from one side to the opposite side, dividing the interior 34 into upper and lower chambers 54, 56, but the divider wall 52 includes a plurality of apertures along the length of the divider wall 52, that are sized and shaped to allow coolant to flow from one chamber to another, depending on the location of the respective locations of the inlet and outlet ports 46, 48 in relation to the upper and lower chambers 54, 56. In another alternative, there may be no divider wall in the interior 34 of the main body 24, and coolant is free to flow throughout the interior 34 of the main body 24. Alternatively, when the inlet port 46 is located on one side of the main body 24, and the outlet port 48 is located on the opposite side of the main body 24, the divider wall is not required and coolant flows in one direction from the inlet port 46 to the outlet port 48. In a further alternative, the inlet port 46 may be located such that coolant enters the lower chamber 56 and then moves up into the upper chamber 54 and exits from the outlet port 48.

The exterior surface 50 of each hollow cylinder 36 includes a plurality of ribs 58. The ribs 58 provide increased heat exchange surface for contact with coolant flowing over the exterior surface 50 of each hollow cylinder 36. Coolant flowing around each hollow cylinder 36 contacts at least a portion of the ribs 58.

The main body 24 is of single-piece construction, and may be constructed using 3D printing. In the alternative, the main body 24 may be integrally constructed from individual components. Alternatively, the main body 24 (or the individual elements thereof) may be constructed using other techniques that include, without limitation, injection molding. The main body 24 may be made from various materials including, without limitation, a dielectric thermally conductive material; any plastic material; a thermally conductive plastic, metal or other suitable material. The size and shape of the main body 24 can be accommodated to any space available.

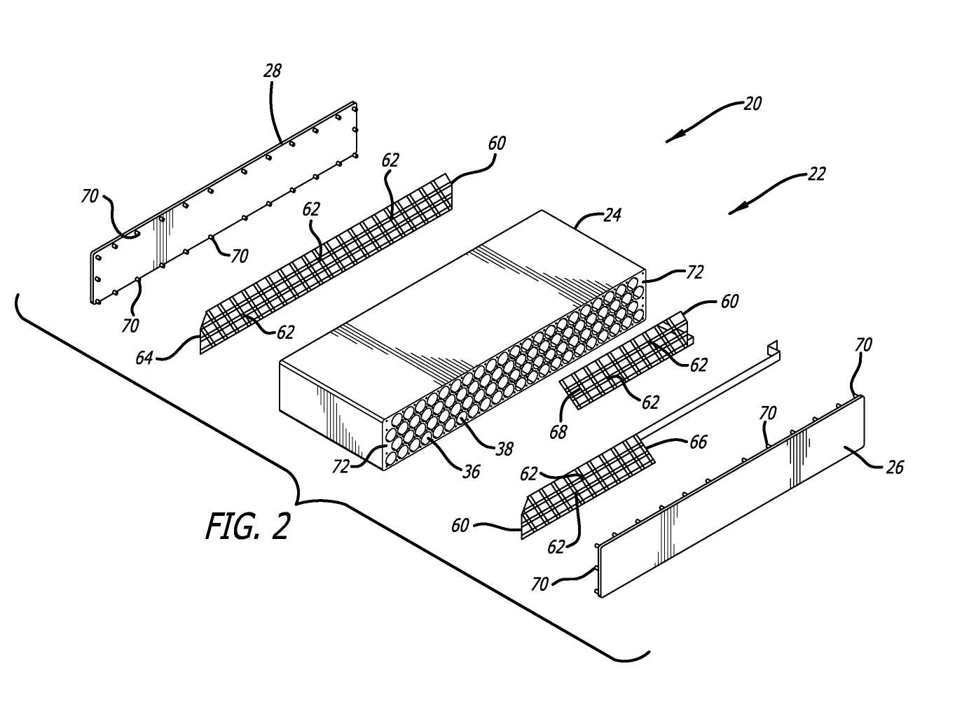

The assembly includes a number of bus bars 60, with each bus bar 60 configured to provide electrical communication between at least two battery cells. At least one (1) bus bar 60 is disposed between the front cover 26 and the main body 24, and is configured to electrically engage battery cells disposed within the hollow cylinders 36 on the front side 30 of the main body 24. At least one (1) bus bar 60 is disposed between the rear cover 28 and the main body 24, and is configured to electrically engage battery cells disposed within the hollow cylinders 36 on the rear side 32 of the main body 24. The bus bars 60 associated with the front and rear covers 26, 28 can be negative or positive or a combination thereof, depending on the series and parallel configuration of the assembly 20. Usually, depending on the number of battery cells in the assembly 20, there are a larger number of battery cells connected in parallel and a fewer number of battery cells connected in series. For example, a battery pack module assembly 20 can be 6S44P (i.e., there are six (6) batteries connected in series and forty four (44) in parallel). If three (3) battery cells are positioned in each hollow cylinder 36, the bus bars 60 associated with each cover 26, 28 are then designed to achieve a desired serial/parallel configuration. However, any desired serial/parallel configuration can be achieved. The bus bar configuration is designed accordingly to the voltage requirements of the assembly 20, and the battery cell arrangement in the main body 24. As seen in FIG. 2, for example, there is a rear bus bar 64 associated with the rear cover 28, but there is a front positive bus bar 66 and a front negative bus bar 68 associated with the front cover 26. A divided bus bar configurations provides voltage build-up. For example, if each battery cell is 3.6 volts, and there are three (3) battery cells in a stack, the voltage of the battery cell stack will be 10.8 volts. If the bus bar configurations were identical on both sides of the main body 24, a total voltage of the assembly 20 would be only 10.8 volts. However, if the bus bar configuration is divided, as seen in FIG. 2, the divided configuration creates more battery cell stacks in series. If one of the bus bars is divided, then it creates a total of six (6) battery cells in series, and the total voltage of the assembly 20 will go up to 21.6 volts. Any configuration of the bus bar and a number of battery cells stacked together can be used. For example, there may be a battery pack module assembly that has single battery cell in a single cylinder 36.

The bus bars 60 are designed in a tilted lattice configuration. Each bus bar 60 includes one (1) or more recessed points 62 stamped into the bus bar 60, and configured to engage the positive and/or negative terminals of the battery cells in each hollow cylinder 36 having terminals that are located at the front and rear sides 30, 32 of the main body 24, and generally co-planar therewith. The recessed points 62 are disposed at the intersection of two (2) pieces of the lattice. The recessed points 62 of the bus bars 60 on opposite sides of the main body 24 each provide compression against a side (i.e., a terminal) of the battery cell facing that particular bus bar 60 such that there is electrical contact between the bus bars 60 and the battery cells. Bus bars 60 on opposite sides 30, 32 of the main body 24 each provide compression against ends (i.e., terminals) of the battery cell(s) facing outwardly from the hollow cylinder 36 such that there is electrical contact between the bus bars 60 and the battery cell(s).

The bus bars 60 may be made from various electrically conductive materials including, without limitation, cooper, aluminum, gold, and other highly conductive materials. The tilt or recession of the lattice of each bus bar 60 allows each of the recessed points 62 (e.g., a center rounded spot) to be aligned with the longitudinal center of the particular battery cell engaged by that recessed point 62 in order to provide mechanical compression of the recessed points 62 against the terminal of the battery cell. In the alternative, laser or resistance welding may be used to engage the recessed points 62 (e.g., center rounded spots (not shown)) configured to engage a battery cell terminal.

In the alternative, when the hollow cylinders 36 are sized to accommodate at least two (2) stacked battery cells, each recessed point 62 is configured to engage one (1) of the terminals of the stacked battery cells. The recessed points 62 provide compression between the stacked battery cells, with the recessed points 62 acting like springs. Bus bars 60 on opposite sides 30, 32 of the main body 24 each provide compression against a side (i.e., terminal) of the stacked battery cells facing those particular bus bars 60 such that there is electrical contact between the bus bars 60 and the stacked battery cells (which also provides compression (which also furthers electrical contact) between the battery cells of the at least two stacked battery cells). Mechanical compression is preferred due to ease of manufacture. If mechanical compression is employed, an electrically conductive compound may be used to increase conductivity.

The front cover 26 includes a plurality of male fasteners 70, and the main body 24 includes a plurality of female fasteners 72 for matingly engaging the male fasteners 70 of the front cover 26. The front cover 26 and the main body 24 matingly engage when the male and female fasteners 70, 72 matingly engage. Likewise, the rear cover 28 includes a plurality of male fasteners 70, and the main body 24 includes a plurality of female fasteners 72 for matingly engaging the male fasteners 70 of the rear cover 28. The rear cover 28 and the main body 24 matingly engage when the male and female fasteners 70, 72 matingly engage. The male fasteners 70 may be in various forms including, without limitation, expandable clips. The female fasteners 72 may be in various forms including, without limitation, a recess sized and shaped to fit the expandable clip. The recess 72 is sized such that the walls of the recess 72 compress the resilient expandable head 74 of the clip 70 as the clip 70 enters the recess 72 until the head 74 reaches a chamber portion 76 of the recess 72 shaped to receive the head 74, at which point head 74 begins to expand until the head 74 contacts the walls of the chamber portion 76. The recess 72 is formed within the main body 24 such that the chamber portion 76 is disposed within a portion that appears as a post 86 on the inner wall of the main body 24. When the clips 70 are held within the recesses 72, the covers 26, 28 are removably engaged to the main body 24. When a user wishes to remove one or both of the covers 26, 28, the user pulls on the desired cover 26, 28, which in turn pulls the clips 70 from the recess 72. As force is exerted to remove the desired cover 26, 28, the walls of each recess 72 compress the resilient expandable head 74 of the clip 70 associated with that recess 72 until the head 74 is free from the recess 72. Alternatively, other fasteners can be used including, without limitation, pins, clips, latches, straps, hook and eye fasteners, toggle fasteners, snaps (male and female), male/female engaging fasteners, magnetic fasteners, or the like. Other alternatives include bolts that will go through the main body 24 and covers 26, 28; pins that will be melted down securing the covers 26, 28; or screws that can pass through the covers 26, 28 and matingly engage recesses on the main body 24. The fasteners 70 may be of single-piece construction with the covers 26, 28. Alternatively, the male fastener 70 may be of single-piece construction with the main body 24, and the female fastener 72 formed into the covers 26, 28.

The main body 24 further includes a plurality of struts or supports 78 interconnecting the hollow cylinders 36 and the main body 24. The number of supports 78 required depends on the size of the main body 24 and number of hollow cylinders 36. The supports 78 are used to connect the hollow cylinders 36 to the interior sides of the main body 24. The main body 24 also includes a plurality of struts or supports 80 interconnecting the hollow cylinders 36. The number of supports 80 required depends on the size of the main body 24 and the number of hollow cylinders 36.

The main body 24 further includes electrically conductive material or circuitry 82 that provides electrical connection between a battery management system 84 and battery cells for balancing and cell voltage monitoring, state of charge and state of health calculation. The battery pack module assembly 20 includes the circuitry 82 to allow monitoring of the voltage on every single battery cell. The circuitry 82 may be 3D printed integrated circuitry (using electrically conductive material that can be 3D printed) for balancing and cell voltage monitoring. This allows for all battery cells to be monitored. The conductive circuitry 82 may be routed anywhere along the exterior and/or interior of the main body 24 so that the conductive circuitry 82 is electrically connected to each battery cell. The conductive circuitry 82 may be routed through various structures including, but not limited to, supports 78, 80 and the divider wall 52 to reach the battery cells. Each battery cell has contact with circuitry 82 but some circuits 82 are shared (e.g., by stacked battery cells) to reduce complexity. The battery pack module assembly 20 provides uniform thermal management of cylindrical battery cells inserted in the assembly 20. The battery management system 84 may include a computing device that can store information in a memory accessible by the one or more processors, including instructions that can be executed by the one or more processors. The memory can also include data that can be retrieved, manipulated or stored by the processor. The memory can be of any non-transitory type capable of storing information accessible by the processor, such as a solid state hard drive (SSD), disk based hard-drive, memory card, ROM, RAM, DVD, CD-ROM, Blu-Ray, write-capable, and read-only memories. The instructions can be any set of instructions to be executed directly, such as machine code, or indirectly, such as scripts, by the one or more processors. In that regard, the terms “instructions,” “application,” “steps,” and “programs” can be used interchangeably herein. The instructions can be stored in a proprietary or non-proprietary language, object code format for direct processing by a processor, or in any other computing device language including scripts or collections of independent source code modules that are interpreted on demand or compiled in advance. Data may be retrieved, stored or modified by the one or more processors in accordance with the instructions. For instance, although the subject matter described herein is not limited by any particular data structure, the data can be stored in computer registers, in a relational or non-relational database as a table having many different fields and records, or XML documents. Moreover, the data can comprise any information sufficient to identify the relevant information, such as numbers, descriptive text, proprietary codes, pointers, references to data stored in other memories such as at other network locations, or information that is used by a function to calculate the relevant data.

In use, a main body 24 is manufactured to accommodate the size and shape of a space available for the battery pack module assembly 20 as well as electrical needs. Once the electrical needs are known, the number of hollow cylinders required (and number of stacked/un-stacked battery cells) may be determined along with the arrangement of the battery cells in parallel/series configuration. The bus bar pattern is designed accordingly to the battery cell arrangement in the main body 24. The arrangement of hollow cylinders 36 allows for a maximum number of battery cells to be placed in a given volume, with proper thermal management. The main body 24 and the covers 26, 28 may be constructed using 3D printing techniques. The bus bars 60 may also be constructed using 3D printing either alone or as part of constructing the covers 26, 28. Once the main body 24 and covers 26, 28 are ready, battery cells may be inserted within the hollow cylinders 36, and the covers 26, 28 attached to the main body 24 using the fasteners 70, 72. The battery cell assembly 20 may then positioned within the desired space and connected to coolant (e.g., appropriate connections are made between the inlet and outlet ports 46, 48 and the coolant reservoir and pump) and electrical systems (e.g., appropriate connections are made between circuitry of the main body 24 and a wire harness of the electrical system of, for example, an electric vehicle).

Although the present invention has been discussed above in connection with use on an electric automobile, the present invention is not limited to that environment and may also be used on other fully-electric or hybrid vehicles including, but not limited to, space vehicles, buses, trains, carts, carriages, and other means of transportation.

Likewise, the present invention is also not to be limited to use in vehicles and may be used in non-vehicle or stationary environments. The present invention can be used to build battery packs for numerous applications including, without limitation, electric vehicles, hybrid vehicles, energy storage, locomotives, aerospace vehicles, marine vehicles, and many other applications that require battery packs. Furthermore, the present invention is also not to be limited to use in connection with electric vehicles, and may be used in any environment where electrical power is required.

In addition, the claimed invention is not limited in size and may be constructed in miniature versions or for use in very large-scale applications in which the same or similar principles of motion and friction control as described above would apply. Likewise, the length and width of the battery pack module are not to be construed as drawn to scale, and that the lengths/widths of the battery pack module may be adjusted in conformance with the area available for its placement. Furthermore, the figures (and various components shown therein) of the specification are not to be construed as drawn to scale.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “front,” “rear,” “left,” “right,” “inner,” “outer,” “beneath”, “below”, “lower”, “above”, “upper,” “horizontal,” “vertical” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A battery pack module assembly, comprising:
a housing comprising a main body, a first cover, and a second cover, wherein the first cover matingly engages a first side of the main body, and the second cover engages a second side of the main body, wherein the first and second sides of the main body are on opposite sides of the main body;
wherein the main body includes an interior having a plurality of hollow cylinders, each hollow cylinder configured for insertion of at least one battery cell within an interior of the hollow cylinder, an inlet for coolant moving into the interior of the main body, and an outlet for coolant moving out from the interior of the main body, wherein the interior of the housing is configured for coolant to flow therewithin and around at least a portion of an exterior surface of each hollow cylinder, whereby coolant does not contact battery cells disposed within hollow cylinders; and
a plurality of bus bars, wherein each bus bar is configured to provide electrical communication between at least two battery cells.

2. The battery pack module assembly of claim 1, wherein the main body further comprises a divider wall defining the interior of the main body into upper and lower chambers, the upper and lower chambers being configured such that coolant is flowable from one chamber to the other chamber.

3. The battery pack module assembly of claim 1, wherein the exterior surface of each hollow cylinder includes a plurality of ribs for providing increased heat exchange surface with coolant, wherein coolant flowing around each hollow cylinder contacts at least a portion of the ribs.

4. The battery pack module assembly of claim 1, wherein the main body is of single-piece construction.

5. The battery pack module assembly of claim 1, wherein the main body is constructed using 3D printing.

6. The battery pack module assembly of claim 1, wherein the main body comprises dielectric thermal conductive.

7. The battery pack module assembly of claim 1, wherein a first end of each hollow cylinder is open on the first side of the main body.

8. The battery pack module assembly of claim 1, wherein a second end of each hollow cylinder is open on the second side of the main body.

9. The battery pack module assembly of claim 1, wherein at least one of the bus bars is disposed between the first cover and the main body, and configured to electrically engage battery cells disposed within the hollow cylinders on the first side of the main body.

10. The battery pack module assembly of claim 1, wherein at least one of the bus bars is disposed between the second cover and the main body, and configured to electrically engage battery cells disposed within the hollow cylinders on the second side of the main body.

11. The battery pack module assembly of claim 1, wherein the first cover includes a plurality of male fasteners, and the main body includes a plurality of female fasteners for matingly engaging the male fasteners of the first cover, whereby the first cover and the main body matingly engage when the male and female fasteners matingly engage.

12. The battery pack module assembly of claim 1, wherein the second cover includes a plurality of male fasteners, and the main body includes a plurality of female fasteners for matingly engaging the male fasteners of the second cover, whereby the first cover and the main body matingly engage when the male and female fasteners matingly engage.

13. The battery pack module assembly of claim 1, wherein each bus bar includes at least one recessed point configured to engage the battery cell in each hollow cylinder, and wherein bus bars on opposite sides of the main body each provide compression against a side of the battery cell facing that particular bus bar such that there is electrical contact between the bus bars and the battery cell.

14. The battery pack module assembly of claim 1, wherein the hollow cylinders are sized to accommodate at least two stacked battery cells, wherein each bus bar includes at least one recessed point configured to engage the at least one of the stacked battery cells in each hollow cylinder, and wherein bus bars on opposite sides of the main body each provide compression against a side of the stacked battery cells facing that particular bus bar such that there is electrical contact between the bus bars and the stacked battery cells, and to provide compression between the at least two stacked battery cells.

15. The battery pack module assembly of claim 1, wherein the main body further includes a first plurality of supports interconnecting the hollow cylinders and the main body.

16. The battery pack module assembly of claim 1, wherein the main body further includes a second plurality of supports interconnecting the hollow cylinders.
